(19) United States
(12) Patent Application Publication
(10) Pub. No.: US 2011/0025469 A1
(43) Pub. Date: Feb. 3, 2011

(54) METHOD OF COMMISSIONING A DEVICE ARRANGEMENT

(75) Inventors: Bozena Erdmann, Aachen (DE); Armand Michael Marie Lelkens, Heerlen (NL); Oliver Schreyer, Herongenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/936,550

(22) PCT Filed: Apr. 9, 2009
(86) PCT No.: PCT/IB09/51505

§ 371 Date: Oct. 6, 2010

(30) Foreign Application Priority Data
Apr. 18, 2008 (EP) 08103614.7

(51) Int. Cl. H04Q 5/22

(52) U.S. Cl. 340/10.1

(57) ABSTRACT

The invention describes a method of commissioning a device arrangement comprising a number of devices (L1, L2, L3,) communicating with each other over a wireless networked control system (WN). This method comprises the steps of—reading a unique identifier (ID1, ID2, ID3) from an electronic identification tag (T) which is tagged to a device (L1, L2, L3) currently to be installed by means of a reading device (3) carried by an installer who is to install the device (L1, L2, L3), and—compiling an inventory (IV) of the installed devices (L1, L2, L3) using the read unique identifiers (ID1, ID2, ID3),—commissioning of the devices (L1, L2, L3) using the inventory (IV). The invention further describes a commissioning system (100) for commissioning such a device arrangement, a data logger and an installation tool (1) for installing devices (L1, L2, L3,) usable in such a commissioning system (100).

### FIELD OF THE INVENTION

The invention describes a method of commissioning a device arrangement comprising a number of devices communicating with each other over a shared medium based networked control system. The invention further describes a commissioning system for commissioning such a device arrangement, a data logger and an installation tool for installing devices usable in such a commissioning system.

### BACKGROUND OF THE INVENTION

Use of shared medium based networked control systems is becoming widespread in business (commercial, industrial, institutional) and also consumer markets for the automated control of various device arrangements. Examples are building automation systems, e.g. for lighting, heating & ventilation, safety, consisting of devices like light ballasts, switches, dimmers or other control elements, daylight/occupancy sensors, actuators, meters etc. A shared medium based network is to be understood as a network in which a number of devices communicate with each other using/sharing the same transmit medium or channel. Typical examples are Powerline, Ethernet or wireless networks. Use of wireless control makes the automation devices independent of the mains power as control medium, thus allowing freedom of device placement, since the devices are no longer dependent on power wires and power outlets; or even device portability, at least for those devices which may be battery-powered such as switches, sensors. Typical example for such wireless personal networks (WPAN) are ZigBee (IEEE 802.15.4), Bluetooth, HomeRF or Wi-Fi.

However, the price to pay for the convenience of such network systems is an increased security risk and a higher maintenance effort, particularly the complex initial system configuration or setup. As part of the setup, configuration of application logic must be performed, i.e. the physical power and/or control cable must be replaced by configuring a logical connection which establishes a control relationship between the devices based on their properties, such as e.g. type and location; specifying for example in a lighting system which switch should control which lamp(s). The whole process of collecting and grouping device identifiers as well as the application logic design together with the above mentioned configuration of the application logic will be referred to as “commissioning” in the following. In addition, since communication crosses building boundaries, the security mechanisms should be bootstrapped, e.g. to allow for encryption and authentication.

In the following, as most shared medium based networks are wireless networks, the term “wireless network” may also be used as a synonym for other shared medium based networks if not otherwise stated or given by the context.

The commonly used state-of-the-art method of commissioning large building lighting systems consists of the following steps:

The installer is given a paper floor plan, indicating intended locations of the devices (lamps, switches, etc.) and a cart filled with the devices to be installed.

Each of these devices has an individual barcode glued to the box and/or to the device itself. The barcode contains the device's unique address and, optionally, the device's initial unique key.

Upon installing each device, the installer tears off the device's barcode from the box/device and sticks it onto the paper floorplan at the appropriate location.

After installation is finished, a barcode reader is used to read the device identifiers from the paper floorplan to create an electronic representation of the floorplan, for instance in a central monitoring tool.

Once the electronic representation has been generated, the application configuration can be performed remotely.

This state-of-the-art procedure has the following drawbacks:

Additional, very precise operation is required on the part of the installer in placing the barcodes on the floorplan.

The procedure is prone to errors since mistakes can easily be made while affixing the barcodes to the paper floor plan, and in reading the barcodes into the electronic floorplan.

Mistakes may be noticed only after generation of the electronic representation and application configuration; furthermore, the errors are awkward and costly to repair since a manual re-commissioning is required in most cases.

In an attempt to address these deficiencies, an auto-commissioning procedure is proposed in EP 1 514 381 B1, which requires the devices to measure the time-of-flight and signal strength of wireless signals, to be evaluated on a central device. Unfortunately, these features are not supported by standard 802.15.4/ZigBee radio modules. Moreover, the process may be unreliable due to changing propagation conditions, varying antenna characteristics between the devices and—especially in case of lamps—due to metal casings which result in strong attenuation of the signal. Moreover, such a centralized approach results in heavy data traffic and processing load on the commissioning PC itself and on its neighbor nodes for collecting and calculating or forwarding all location data.

Therefore, it is an object of the invention to provide a better method and commissioning system for commissioning a device arrangement while avoiding the problems mentioned above.

### SUMMARY OF THE INVENTION

To this end, the present invention describes a method of commissioning a device arrangement comprising a number of devices communicating with each other over a wireless networked control system, which method comprises the following steps:

A unique identifier is seamlessly read from an electronic identification tag which is tagged to a device currently to be installed by means of a reading device carried by an installer who is to install the device. The unique identifier may be any individual data for identifying the device such as the globally unique device's hardware address. Thereby, the term “unique” means that the identifier is at least unique with regard to the device arrangement so that two different devices addressed in the same network may not be confused. Suitable reading devices which may be carried or worn by the installer will be explained later in detail.

An inventory of the installed devices is compiled using the read unique identifiers.

Finally, the application logic for devices of the device arrangement is configured, preferably in a fully automatic way, using the inventory.

One obvious benefit of this solution that the information pertaining to the installation, necessary for the further commissioning of the device arrangement, may be collected during the usual tasks of the installer, without requiring any additional time-consuming and error-prone step. On the other hand, in contrast to known auto-commissioning procedures, the proposed method does not rely on established network infrastructure and thus can be applied quite early in the network setup process and does support piecemeal network installation. Furthermore, the method does not require considerable amounts of time or bandwidth.

The tagging of each device with an electronic identification tag and associating the device with a unique identifier by storing it in a memory of the identification tag can be carried out at any suitable point in time prior to installing the device, for example the devices may already be tagged and allocated to the identifier, for example an IEEE address, by the manufacturer of the device. In another embodiment, the devices are provided with the electronic identification tag by a manufacturer of the device, and an engineering company entrusted with the design and/or installing of the device arrangement provides for the allocation of the identifiers to the devices used in the device arrangement, which identifiers must be unique regarding the other devices of the device arrangement.

An appropriate commissioning system for commissioning a device arrangement comprises a number of electronic identification tags each tagged to a specific device of a device arrangement to be installed, and each associated with a unique identifier. The commissioning system further comprises a reading device carried by a device installer, for reading the unique identifier from an electronic identification tag which is tagged to a device currently being installed, a compiling unit for compiling an inventory of the installed devices using the read unique identifiers, and a commissioning control system for controlling the application logic configuration process of the devices using the inventory. The commissioning control system may, for example, comprise an interface realised to send application configuration data to the devices of the wireless networked control system used by the device arrangement. If, as preferred, the wireless networked control system is a ZigBee network, the commissioning control unit may comprise a ZigBee interface capable of binding or group membership data to the ZigBee devices.

The reading device which is realised to automatically read a unique identifier from an electronic identification tag tagged to a device currently being installed by an installer may preferably be incorporated in a data logger comprising also a compiling unit for compiling an inventory of the installed devices using the read unique identifiers, whereby, as explained later, the unique identifier of the installed devices may be written into the inventory in a chronological sequence in which the devices have to be installed. Preferably, the data logger may also comprise an interface for sending commissioning control signals to the commissioning control system of the wireless networked control system. Such a data logger according to the invention may be carried by the installer all the time while installing the devices. For example, the data logger may be integrated in a watch, a special wristband, or any other appropriate tool or item worn by the installer.

In a preferred embodiment, the installer uses an installation tool to install the devices, which installation tool comprises the data logger or reading device. The installation tool and the reading device are realised so that the reading device may read a unique identifier from an electronic identification tag tagged to the device currently to be installed by means of the installation tool, seamlessly during installer's usual tasks.

The reading device carried by the installer allows for seamless and completely automated collecting of the identifier and further specific device data during the normal installation procedure. Therefore, a simple, yet error-free procedure for network commissioning during installation is given that can be executed by an average electrician, which procedure does not require wireless knowledge and does not delay the electrician at work. As will be explained in detail below, besides the identifier or coded in the identifier, the tag may store further device specific data such as a security key of the device or a device type etc., which may be read by the reading device and used in the commissioning process.

The invention is preferably used for lighting arrangements but may be used for all other device arrangements for automation applications (HVAC, safety, security, metering, etc.), for building, hospitality, retail, industry, offices or outdoor.

The dependent claims and the subsequent description disclose particularly advantageous embodiments and features of the invention, whereby, in particular the commissioning system, the data logger and the installation tool according to the invention may be further developed according to the dependent method claims.

There are a number of ways in which the identifier may be read from the electronic identification tags depending on the tag type.

In a preferred method the electronic identification tags are radio-frequency identification (RFID) tags and the identifier is transmitted with a preferably very short-range radio frequency technology, for example an RFID technique with a range of several centimetres. The use of a very short range communication based on inductive coupling ensures that the reading device only reads the identifier from a device currently being installed, and not from other devices in the vicinity. Active or passive RFID tags may be used as appropriate.

Alternatively, a different tagging technology could be used, whereby the tags and the reading device are preferably realised such that the reading process does not require line-of-sight between the tag and the reading device.

For devices which may not necessarily be connected to a mains supply, tags such as passive RFID tag, that do not require mains power, are preferably used.

The placement of the tag should be carefully carried out such that:

(i) The position of the tag does not result in the tag being destroyed (even in case of a fault during operation), for example, through overheating, mechanical forces, electromagnetic emission or current spikes.

(ii) The tag does not influence the device's basic function, for example, by being visible in emitted light if the device is a lamp.

(iii) The position allows for the tag to be read from the outside, for example, if an RFID tag is used it should not be covered by a metal casing of the device, at least not during installation.

(iv) It must be ensured that the reading device carried by an installer comes within a communication distance to the tag during normal installation operations.

In a particularly preferred method, when the reading device is incorporated in an installation tool for installing the devices, the unique identifier is only read from the electronic identification tag when the installation tool makes contact with the device or with a specific part of the device. This is an easy way to ensure that only the identifier of the currently installed device is read.

In such an embodiment of the tag, the device to be installed and the reading device in the installation tool may be realised to read the identifier via a communication channel arising through an electrical connection made between the tag and the reading device. For example, an electrical contact of the tag may be electrically connected to a metal nut required to mount of the device to a wall or ceiling, and the installing device may be a screwdriver whose metal tip is connected to an electrical contact of the reading device integrated in the handle of the screwdriver.

In the simplest version, the procedure according to the invention allows for an easy and fool-proof generation of a list of all installed devices. Moreover, by collecting the information on the installed devices, this invention also allows for a grouping of devices. That means the devices of the device arrangement are grouped into functional groups using the unique identifiers of the devices and according to given grouping information, e.g. a grouping rule. Later, the devices of the device arrangement can be commissioned according to the functional groups to which the devices belong. An example for different functional groups may be a group of lighting devices illuminating a specific area and controlled by a certain switch, for example, all lights in a specific room, corridor or staircase, or, in a larger room, all lighting devices used to illuminate a specific area in that room. Another functional group may be a group of drivers for blinds or shutters for the windows of a room.

The grouping of the devices requires one additional step for each group of devices, namely a group initialisation.

In one embodiment the grouping information may be received via a user interface. This user interface may preferably be integrated in the reading device. In its most basic form, the user interface may be a simple button on the reading device or installing tool. However, more elaborate user interfaces may be employed, such as a keypad or a speech-based user interface.

For example, the installer would have just to press a button on the tool with the integrated reading device to indicate that a new group or location starts. This may be particularly practical in new, still incomplete buildings, where no names or room numbers have been yet assigned to the rooms. Another possibility is that the installer can enter the actual room number or name, for example, via a speech-based user interface. The utterance of the user may be processed and translated to text directly in the installer's device or after the data have been transferred via a wireless interface into a more capable device e.g. a central system controller. Alternatively the room number could be stored on a tag, in particular an RFID tag integrated, for example, into the room name/number plate. In this example the installer just needs to pass the installing tool over the surface of the plate. A tag with the room number could also be glued to the intended location of a switch to be installed, for example, at a location close to the door so that it can be automatically read while the switch is being installed.

In an embodiment requiring no additional action on the part of the installer, the grouping information may be deduced from a chronological sequence of reading the unique identifiers associated with the devices. This makes it possible to deduce the start of a new group from the usual work of the installer. For example, if the door-side switch is always installed first, since it is the first device next to the door and it does not require the use of a ladder, the installation of a door-side light switch could indicate a new group and/or a new room.

In particular in such a scenario, preferably the commissioning control system resolves the device types and also device grouping based on the order of device installation, in the process of defining the control relationships. Alternatively, to identify the switches and the different lighting devices, a device type can be deduced using the unique identifier assigned to the specific device. This may be realised by coding the device type information in the unique identifier. As an alternative the device type information may be stored as a separate entry in the tag. A further possibility is to send a request to a data base in which information about the device type is stored, associated with the unique identifiers of devices, or to send a request to the device itself. Obviously, the information about the device type may also be entered via a user interface.

Grouping information may also be deduced from position information representing the position at which the specific devices are installed. This position information may also be entered via the user interface.

Obtaining position information may be beneficial not just for grouping, since another important task in systems with high setup complexity, especially in large installations, is the mapping between a unique identifier and the physical location of particular devices.

As already mentioned above, security information such as keys may also be stored in the electronic identification tags and read by the reading device. This security information may also be a derivative of the identifier. The security information may be used for establishing the network connections. For example, the individual keys can be used to encrypt the transfer of the network key.

The digital data, in particular the unique identifiers, the positioning information of the installed devices, the grouping information, or the security information collected by the installer can be transferred from the item with the reading device carried by the installer into a commissioning control system, i.e. more capable device such as a central system monitor unit. This commissioning control system may compile the inventory and may send the necessary network and/or application configuration information to the wireless network or interfaces of the devices used in the wireless network. For example, in a ZigBee network for a lighting arrangement, the ZigBee nodes comprising the switches may be provided with the necessary information about all lighting devices belonging to the functional group of the switch. In the same way, all lighting device nodes may be provided with the information about the group identifier of the group to which they should belong, controlled by a particular switch sending to this group address. The functions of such a commissioning control system may also be distributed over several devices, which may communicate with each other.

If the item with the reading device is equipped with an appropriate communication interface, the installation data could be uploaded into the commissioning control system in real time, thus allowing for better tracking of the installer's progress, design of application functionality and simplified system check and, if necessary, re-commissioning.

As an alternative, the transfer of the data from the item with the reading device to the commissioning control system can be done after installation of at least a part of the system is finished, for example after installation of each storey in a building. Therefore, as already explained above, in a preferred embodiment the reading device is directly connected to a compiling unit for compiling the inventory of the installed devices in an integrated data logger.

In a more elaborate device arrangement, a device may have different functions and/or may comprise more than one functional unit. For example, especially in office buildings, it often happens, that the light switch at the door has two separate buttons, and each button controls a separate group of lights in the room, for instance to independently illuminate two distinct working spaces in this office, or to indicate different functional areas for example a desk area and a meeting area. Most probably, at lighting installation time, the location of the furniture and thus the number, location and type of the functional areas may not be known yet, so it cannot be configured by the electrician. This grouping, together with more advanced application logic, could be added later by building maintenance; and can utilize the already available information about device grouping, location, type, and/or installation order.

On the other hand, if the grouping of the devices within one room and the assignment to the switch buttons be known at installation time, a unique identifier may be assigned to each function or functional unit of the device. For example a two-button switch may be equipped with two electronic tags which also host a ZigBee EndPoint number as well as the hardware address or other optional parameters. As an alternative, more than one unique identifier may be stored in the electronic identification tag of the device which has different functions and/or comprises more than one functional unit. Later, an installer may initialise each of the groups independently. In the given example of the two-button switch for two independent lighting device groups, the buttons of the switch and the corresponding tags may have obvious identifiers such as “left” or “right” so that the corresponding lamp group can be easily initialised, for example, by means of a graphic user interface of a central system monitor, or via voice commands.

The proposed procedure, apart from simplifying the installer's job and reducing the number of commissioning errors, enables the following extended features.

The solution provides the installer with simple means for checking whether the installation was successful. Some test unit could send a test message via the wireless interface (e.g. 802.15.4/ZigBee) to each installed node and log the responses to ensure that all devices are connected to the power supply. This obviates the need to check voltages on particular cables. Preferably, the test unit is integrated in the item with the reading device, e.g. in the installation tool. In special cases such as light units a direct functional check may be applied, i.e. sending a command from a test unit or directly from a switch to a group of lamps, e.g. all lamps in room, so that the installer can visually check whether all lamps are correctly assigned. Should the system response be other than expected, the installer simply has to repeat the usual installation tasks.

If, during the installation procedure, the location information of particular devices is automatically collected, the location information can be immediately provided to the installed devices, for example, by including it in the test message.

The method allows a simple re-commissioning: if new devices are to be added or re-located, the usual installer's tasks are simply repeated.

In addition, the same system can be used for tracking maintenance tasks, for example whether particular status check of temperature, voltage, repairs, etc. were really carried out by the maintenance personnel on all devices.

A programming of an application functionality is simplified: The readily available device location/grouping information can be used to automatically deploy “standard functionality” formulated in an abstract way, e.g. “all lamps in all rooms must react to the occupancy sensor in the same room only during working hours and only if the daylight amount from the daylight sensor in the same room doesn't exceed the threshold value”. It allows the manual application commissioning to be entirely skipped, or to be limited to complex or atypical applications or to personalisation of settings only.

Also, the method according to the invention allows multiple installers to work in parallel, and piecemeal installation to be performed.

Secure network setup is supported, when the commissioning control system forwards the inventory data to control unit of the wireless networked control system. If, as preferred, the wireless networked control system is a ZigBee network, the commissioning control unit may comprise an interface capable of sending all necessary information describing the nodes of the ZigBee network to a ZigBee PAN coordinator, thus allowing the ZigBee PAN coordinator to authenticate the devices in the joining process. Further, if the inventory data also contains individual device keys, also secure association and secure network key exchange can be performed.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 shows a schematic representation of an embodiment of a device arrangement comprising several functional groups of devices in different rooms;

FIG. 2 shows a schematic representation of a group of lighting devices and an installation tool of a commissioning system according to a first embodiment of invention;

FIG. 3 shows a schematic representation of a lighting device and an installation tool of a commissioning system according to a second embodiment of invention.

In the drawings, like numbers refer to like objects throughout. Objects in the diagrams are not necessarily drawn to scale.

### DETAILED DESCRIPTION OF THE EMBODIMENTS

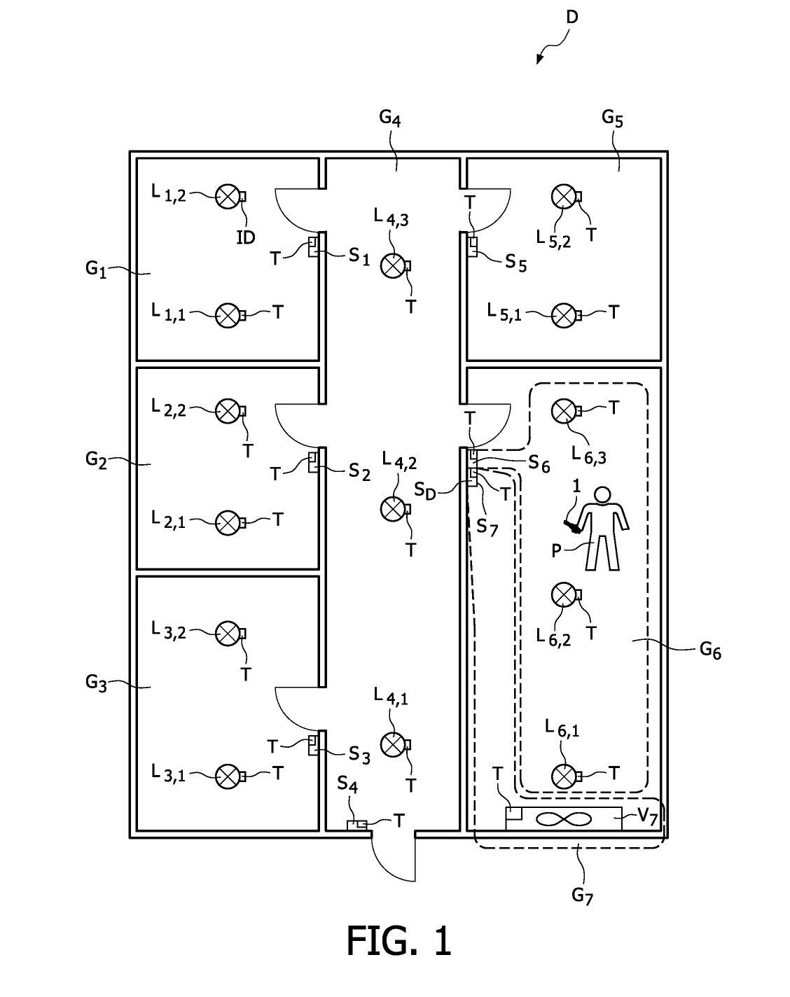

Referring to FIG. 1, a device arrangement D is located on a floor comprising five offices connected by a corridor. The device arrangement D is here essentially a lighting arrangement whereby, for the purposes of showing that the invention is not restricted to lighting systems, one of the devices is a ventilator V₇ as part of an air conditioning system of the offices.

The lighting arrangement comprises a number of lighting elements or luminaires L_{1,1}, L_{1,2}, L_{2,1}, L_{2,2}, L_{3,1}, L_{3,2}, L_{4,1}, L_{4,2}, L_{4,3}, L_{5,1}, L_{5,2}, L_{6,1}, L_{6,2}, L_{6,3}. These luminaires are grouped into functional groups G₁, G₂, G₃, G₄, G₅, G₆ according to the room in which the luminaires are installed. Each group G₁, G₂, G₃, G₄, G₅ also comprises a switch S₁, S₂, S₃, S₄, S₅ for controlling the luminaires of the group G₁, G₂, G₃, G₄, G₅, respectively. In the office with the ventilator V₇, a two-button switch SD is installed with two functional units S₆, S₇, whereby one of the functional units S₆ belongs to the group G₆ of the luminaires L_{6,1}, L_{6,2}, L_{6,3} and the other functional unit S₇ of the two-button switch SD belongs to the ventilator V₇ and forms a separate functional group G₇.

The devices L_{1,1}, L_{1,2}, L_{2,1}, L_{2,2}, L_{3,1}, L_{3,2}, L_{4,1}, L_{4,2}, L_{4,3}, L_{5,1}, L_{5,2}, L_{6,1}, L_{6,2}, L_{6,3}, V₇, S₁, S₂, S₃, S₄, S₅, SD of a group G₁, G₂, G₃, G₄, G₅, G₆, G₇ may communicate with each other using a wireless network. In the preferred embodiment the devices L_{1,1},_{1,2}, L_{2,1}, L_{2,2}, L_{3,1},L_{3,2}, L_{4,1},L_{4,2}, L_{4,3} , L_{5,1}, L_{5,2}, L_{6,1}, L_{6,2}, L_{6,3}, V₇, S₁, S₂, S₃, S₄, S₅, S₆, S₇, SD communicate with each other using the ZigBee standard. Therefore all devices L_{1,1} , L_{1,2}, L_{2,1}, L_{2,2}, L_{3,1}, L_{3,2}, L_{4,1}, L_{4,2}, L_{4,3}, L_{5,1}, L_{5,2}, L_{6,1}, L_{6,2}, L_{6,3}, V₇, S₁, S₂, S₃, S₄, S₅, S₆, S₇ are provided with a ZigBee-interface whereby some of the devices may be constructed to be ZigBee routers and other devices may be constructed as ZigBee End Devices. One of the devices may also be realised as a ZigBee Coordinator which is able to store information about the network including acting as Trust Centre and repository for security keys. Obviously there might also be a special device which acts as a ZigBee coordinator and which has no other specific function such as a switch or luminaire.

All the devices (the switches S₁, S₂, S₃, S₄, S₅, S₆, S₇, the luminaires L_{1,1}, L_{1,2}, L_{2,1}, L_{2,2}, L_{3,1}, L_{3,2}, L_{4,1}, L_{4,2}, L_{4,3}, L_{5,1}, L_{5,2}, L_{6,1}, L_{6,2}, L_{6,3} and the ventilator V₇) are provided with an electronic tag T, for example an RFID tag, which stores an unique identifier associated with the device. An installer P who is to install the devices L_{1,1}, L_{1,2}, L_{2,1}, L_{2,2}, L_{3,1}, L_{3,2}, L_{4,1}, L_{4,2}, L_{4,3}, L_{5,1}, L_{5,2}, L_{6,1}, L_{6,2}, L_{6,3}, V₇, S₁, S₂, S₃, S₄, S₅, SD uses an installation tool 1 comprising an RFID reader for reading the identifier from the tag T of the device currently being installed with the installation tool 1. In this way, an inventory, such as a simple list of all devices installed on the floor (preferably in the order of their installation) is compiled and can be used for further commissioning of the device arrangement D or the ZigBee network.

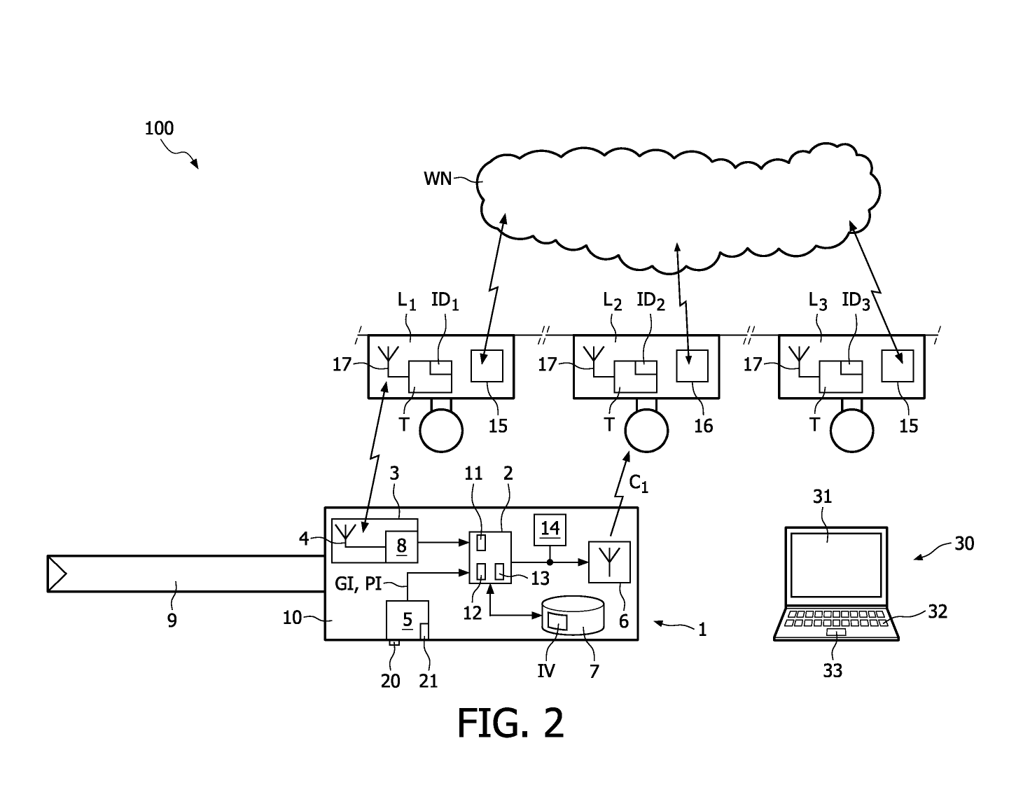

The functionality of the installing tool 1, which acts here as a data logger, will now be explained in more detail with regard to FIG. 2, which shows a commissioning system 100 comprising a number of RFID tags T, each attached to a luminaire L₁, L₂, L₃, an installation tool 1 comprising an RFID reading device 3; and a commissioning control system 30. The commissioning control system 30 here is, for example, a central system control unit in form of a laptop with a display 31, a keypad 32 and a touchpad 33 so that the commissioning control system 30 provides a graphic user interface.

The RFID tags T are attached to a socket of the luminaires L₁, L₂, L₃ in such a way that the RFID tags T are not destroyed by normal operation of the luminaires and that unique identifiers ID₁, ID₂, ID₃ stored in the RFID tags T may be read by a RFID reader from the outside of the casing of the luminaires L₁, L₂, L₃. For example the RFID tags T and/or their antennae 17 (here shown as separate to the tag, but normally integrated into the tag T) may be attached to the inner side of a plastic wall of the casing. Each of the luminaires L₁, L₂, L₃ is additionally provided with a ZigBee-interface 15, 16 over which the luminaires L₁, L₂, L₃ can communicate with each other and with a switch (not shown in FIG. 2) over a ZigBee network WN. Thereby, one of the interfaces 16 is realised to be a ZigBee router which may pass data from other devices and the other interfaces 15 are realised as ZigBee end devices.

The installing tool 1 is here a screwdriver used to mount the casing of the luminaires L₁, L₂, L₃ to wall or ceiling of the room. The screwdriver has metal tip 9 and a handle 10. An RFID reading device 3 is incorporated in the screwdriver's handle 10, which reading device 3 comprises an antenna 4 and all other usual components necessary to read the identifiers, which are here shown as a single functional block 8 for the sake of clarity. Further components integrated in the screwdriver's handle 10 are a control unit 2, a user interface 5, a test unit 14 and an interface 6 for communicating with the commissioning control system 30, for example, a ZigBee or Bluetooth interface.

The RFID tags T in the luminaires L₁, L₂, L₃ and the RFID reader 3 in the handle 10 of the installation tool 1 are realised such that they only act over a very short range when the screwdriver is used to install the respective luminaire L₁, L₂, L₃. In this way it may be ensured that the RFID reading device 3 only reads the identifier ID₁, ID₂, ID₃ of a specific luminaire L₁, L₂, L₃ when the luminaire L₁, L₂, L₃ is currently installed using the installing tool.

Based on the detected identifiers ID₁, ID₂, ID₃, an inventory IV of the installed luminaires L₁, L₂, L₃ is compiled using a compiling unit 11 which may be realised in the controller 2 of the installing tool 1 in the form of a software module. The compiled inventory IV is stored in the memory 7 of the installing tool 1 and may also be transmitted via the interface 6 to the commissioning control system 30.

To allow a grouping of the installed devices L₁, L₂, L₃ into functional groups, grouping information GI maybe provided by the installer by means of the user interface 5 in the handle 10 of the installing tool 1. For example, this user interface 5 may comprise a simple button 20 and the installer only presses the button 20 whenever he commences installation of a new functional group.

Additionally or as an alternative, the user interface 5 may also be equipped with a speech interface 21 by which the user can input verbal control utterances to indicate to which group, for example, to which room name a device belongs which is currently being installed by him. In this way, the installer also gives positioning information PI, for example, in the form of the room number in which the device is installed. Furthermore, he may give some information about the type of the device such as a luminaire or switch. Such device type information may also be encoded in the unique identifiers ID₁, ID₂, ID₃ stored in the RFID tag of the devices or may be stored as a separate entry in the RFID tag.

An engineer may use the commissioning control system 30 with the graphical user interface for application configuration of the whole device arrangement or the wireless communication network system WN using the inventory IV and/or the grouping information GI and/or the positioning information PI received by the interface 6 of the installing tool 1. Thereby, using the graphical user interface, an engineer or technician may make the necessary decision to complete the commissioning of the device arrangement. For example, if a two-button switch is installed in a room such as the switch SD in one of the rooms of FIG. 1 the engineer may decide which of the functional units S₆, S₇ should be assigned to the group G₆ of the luminaires L_{6,1}, L_{6,2}, L_{6,3} and which of the functional unit S₆, S₇ should be assigned to the ventilator V₇ forming the group G₇.

From the commissioning control system 30 the necessary information for the setup of the wireless network WN, here the ZigBee network, will be sent to the interfaces 15, 16 of the ZigBee nodes (the luminaires L₁, L₂, L₃ and the switches not shown in FIG. 2).

The test unit 14 in the installing device 1 may be used to send a test signal from the installation tool 1 directly to one or more of the installed devices L₁, L₂, L₃ in order to test the devices L₁, L₂, L₃. For example if the installer has installed all devices in a room he may issue a test request by the user interface 5 of the installing tool 1, and a test signal is generated by test unit 14 using the unique identifiers of the devices and this test signal may be sent to the respective devices via the interface 6. Therefore, the interface 6 should operate with the same standard as the interfaces 15, 16 of the installed devices, for example, in the embodiment shown in FIG. 2, also in the ZigBee standard.

In a further embodiment shown in FIG. 2 the control unit 2 optionally comprises two further software modules, a grouping unit 12 and commissioning control unit 13. The grouping unit 12 provides for an automatic grouping of the devices based on the identifiers ID₁, ID₂, ID₃ and based on the grouping information GI. The inventory IV then is not only simply a list of the devices L₁, L₂, L₃ but a list in which the devices L₁, L₂, L₃ or the identifiers ID₁, ID₂, ID₃ of the devices L₁, L₂, L₃ are already grouped into functional groups. The commissioning control unit 13 may provide for all necessary signals to send the complete commissioning information which is needed by the devices to setup the ZigBee network. In this case the commissioning information C₁ may be directly sent from the interface 6 of the installing device to one or more of the ZigBee interfaces 15, 16 of the installed devices L₁, L₂, L₃ and further commissioning using the graphic user interface of the commissioning control system 30 is not necessary. This process may, for example, be used in less complicated cases such as when the same application logic is used in all or many rooms

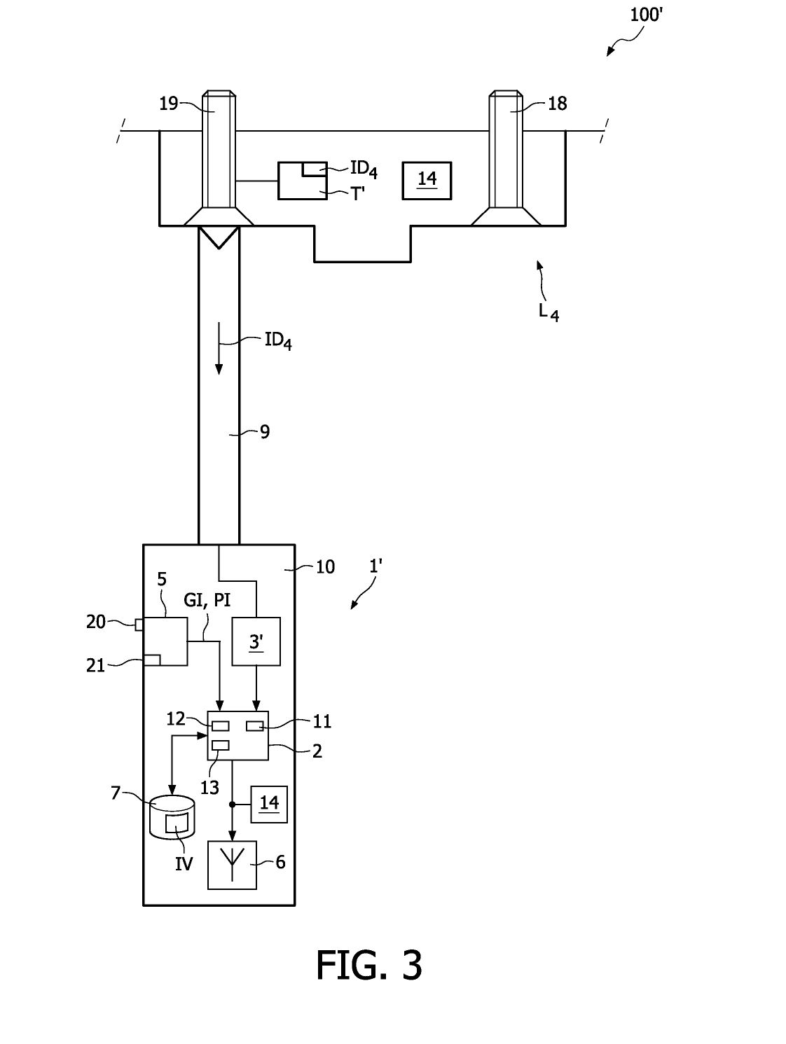

In FIG. 3 a further embodiment of commissioning system 100′ according to the invention is shown. This commissioning system 100′ is very similar to the commissioning system according to FIG. 2. For the purpose of simplicity only one device L₄ is shown which is constructed similar to the devices L₁, L₂, L₃ in FIG. 2 and which also comprises a ZigBee interface 14 for communicating with other devices over a ZigBee network.

In contrast to the devices shown in FIG. 2, a tag T′ is used here instead of a RFID tag T, electrically connected to at least one of the screws 18, 19 of the casing of the luminaire L₄. Accordingly, the reading device 3′ is here, in contrast to the commissioning system 100 of FIG. 2, not an RFID reader but a reader 3′ which is in electrical contact with the metal tip 9 of the screwdriver 1′. In this commissioning system 100′, the identifier ID₄ stored in the electronic tag T′ is read by the reading device 3′ via the electrical connection given by the metal screw 19 and the metal tip 9 of the screwdriver 1′. In this way the identifier ID₄ may only be read by the reading device 3′ if the screwdriver tip 9 is in physical contact with the screw 19, for example, when mounting the luminaire L₄ to the ceiling of the room.

The further components 2, 5, 7, 6, 14 of the screwdriver 1′ and their functionality may be the same as in the screwdriver 1 shown in FIG. 2. In the embodiment shown here, a commissioning control system 30 may also be used for further commissioning of the system as shown in FIG. 2.

Although the present invention has been disclosed in the form of preferred embodiments and variations thereon, it will be understood that numerous additional modifications and variations could be made thereto without departing from the scope of the invention. In particular, instead of a screwdriver any other installation tool suitable for installing the specific devices such as a wrench, an Allen key or preferably a multifunctional installation tool for installing different device types may be realised according to the invention. Instead of an engineering tool, it could be any suitable installer-worn device, such as e.g. watch, bracelet, glove, etc. For the sake of clarity, it is to be understood that the use of “a” or “an” throughout this application does not exclude a plurality, and “comprising” does not exclude other steps or elements. A “unit” or “module” can comprise a number of units or modules, unless otherwise stated.

1. A method of commissioning a device arrangement (D) comprising a number of devices communicating with each other over a shared medium based networked control system (WN),
which method comprises the steps of
reading a unique identifier from an electronic identification tag tagged to a device currently to be installed by means of a reading device, and
compiling inventory of the installed devices using the read unique identifiers,
configuring application logic of the devices using the inventory (IV).

2. A method according to claim 1, wherein the devices of the device arrangement (D) are grouped into functional groups using the unique identifiers assigned to the devices and according to a given grouping information, and the application logic of the devices is configured according to their functional.

3. A method according to claim 1, wherein the electronic identification tags (T) comprise radio-frequency identification tags (T).

4. A method according to claim 1, wherein the reading device is incorporated in an installation tool for installing the devices.

5. A method according to claim 4, wherein the unique identifier is read from the electronic identification tag when the installation tool makes contact with the device or with a predetermined part of the device.

6. A method according to claim 1, wherein grouping information (GI) is received via a user interface (5).

7. A method according to claim 1, wherein grouping information is deduced from a chronological sequence of reading the unique identifiers associated with the devices.

8. A method according to claim 1, wherein a device type is deducible using the unique identifier assigned to the specific device.

9. A method according to claim 1, wherein grouping information is deduced from position information representing the position at which the specific devices are installed.

10. A method according to claim 1, wherein security information is stored in the electronic identification tag and read by the reading device which security information is used for establishing the network connections.

11. A method according to claim 1, wherein the inventory and/or the unique identifiers of the installed devices and/or the device type of the installed devices and/or the position information (PI) of the installed devices and/or the grouping information and/or the security information is transmitted to a commissioning control system which controls the commissioning of the devices.

12. A method according to claim 1, wherein a device has different functions and/or comprises more than one functional units and wherein a unique identifier is assigned to each function or functional unit of the device.

13. A commissioning system for commissioning a device arrangement (D) comprising a number of devices communicating with each other over a wireless networked control system,
which commissioning system comprises
a number of electronic identification tags each tagged to a specific of a device arrangement to be installed, and each associated with a unique identifier,
a reading device which may be carried by an installer (P) who is to install the devices for reading the unique identifier from an electronic identification tag which is tagged to a device currently to be installed,
a compiling unit for compiling an inventory (IV) of the installed devices using the read unique identifiers,
a commissioning control system for controlling the configuration of application logic of the devices using the inventory.

14-15. (canceled)
